(19) United States
(12) Patent Application Publication
(10) Pub. No.: US 2012/0176502 A1
(43) Pub. Date: Jul. 12, 2012

(54) IMAGE ACQUISITION APPARATUS

(75) Inventors: Shogo USUI, Tokyo (JP); Hironori KISHIDA, Tokyo (JP)

(73) Assignee: OLYMPUS CORPORATION, Tokyo (JP)

(21) Appl. No.: 13/338,807

(22) Filed: Dec. 28, 2011

(30) Foreign Application Priority Data
Jan. 7, 2011 (JP) 2011-002008

(51) Int. Cl. H04N 5/232

(52) U.S. Cl. 348/211.99; 348/E05.042

(57) ABSTRACT

The size of an image acquisition apparatus is reduced by reducing the diameter of a cable. An image acquisition apparatus includes a camera unit including a plurality of electric-power elements, which require electric power to acquire an image of an object, and an electric-power switching unit configured to switch an electric power supply to the electric-power elements; a control unit configured to output a switch instruction to the electric-power switching unit and to control the electric power supply to the camera unit; and a cable configured to connect the control unit and the camera unit.

### CROSS-REFERENCE TO RELATED APPLICATIONS

This application is based on Japanese Patent Application No. 2011-002008, the contents of which are incorporated herein by reference.

### BACKGROUND OF THE INVENTION

1. Field of the Invention

The present invention relates to an image acquisition apparatus.

2. Description of Related Art

In the related art, there is a known camera that is used by being mounted on an image acquisition apparatus, such as a microscope, and operated by power and command signals supplied from an externally provided controller (for example, refer to Japanese Unexamined Patent Application, Publication No. 2008-187265).

As disclosed in Japanese Unexamined Patent Application, Publication No. 2008-187265, in a case where multiple elements requiring electric power are disposed in a camera that is operated by power supplied from an external device, if the external device and the elements are connected individually by cables, the size of the camera will increase because a multicore cable will be required. For example, multiple elements that require relatively large power, such as a motor that actuates an optical system for automatic focusing and a Peltier element for cooling an image acquisition element, may be disposed inside the camera.

### BRIEF SUMMARY OF THE INVENTION

The present invention is an image acquisition apparatus which can be reduced in size by reducing the diameter of the cable.

An aspect of the present invention provides an image acquisition apparatus including a camera unit having a plurality of electric-power elements, which require electric power to acquire an image of an object, and an electric-power switching unit configured to switch the electric power supply to the electric-power elements; a control unit configured to output a switch instruction to the electric-power switching unit and control the electric power supply to the camera unit; and a cable configured to connect the control unit and the camera unit.

According to the aspect of the present invention, to operate any electric-power element included in the camera unit, the electric-power switching unit in the camera unit is operated in response to a switch instruction from the control unit to switch the electric-power element that is to be the receiver of electric power, and electric power is supplied from the control unit to the camera unit via the cable. Since power is supplied to the electric-power unit to be operated by the electric-power switching unit in the camera unit, separate electrical lines are not required for every electric-power element, and the size of the image acquisition apparatus can be reduced by reducing the diameter of the cable.

In the aspect described above, the electric-power elements may include an image acquisition element having a cooling device and a driving element configured to move an optical system for guiding light to the image acquisition element.

During image acquisition, the driving element is operated to move the optical system, and then, power is supplied to the cooling device in the image acquisition element, and the image acquisition element is operated. At this time, the receiver of electric power is set as the driving element by the electric-power switching unit to operate the driving element, and then the receiver of electric power is set as the image acquisition device by the electric-power switching unit to acquire an image. In this way, separate electrical lines are not required for the image acquisition element and the driving element, and the size of the image acquisition apparatus can be reduced by reducing the diameter of the cable.

In the aspect described above, the electric-power switching unit may switch the electric power supply before operation of the electric-power elements.

In this way, after preparation for operating the electric-power elements is completed, the electric-power elements can be reliably operated.

In the aspect described above, the electric-power switching unit may switch the electric power supply before operation of the electric-power elements by a time difference set on the basis of at least one of the total power consumption and the load capacity of the electric-power element to which the power supply is switched.

In this way, a time difference can be set between the timing of switching the electric power and the timing of operating the electric-power elements on the basis of at least one of the total power consumption and the load capacity of the electric-power element; and the incoming current to the cable can be distributed to prevent the incoming current from exceeding an allowable value.

According to the present invention, an image acquisition apparatus can be reduced in size by reducing the diameter of the cable.

### BRIEF DESCRIPTION OF THE SEVERAL VIEWS OF THE DRAWINGS

FIG. 1 is a configuration diagram illustrating, in outline, an image acquisition apparatus according to an embodiment of the present invention.

FIG. 2 is a time chart illustrating the operation of the image acquisition apparatus in FIG. 1.

FIG. 3A is a schematic configuration diagram illustrating, in outline, a modification of the image acquisition apparatus in FIG. 1 and illustrates a state in which only a power connection switch is closed.

FIG. 3B is a schematic configuration diagram illustrating, in outline, a modification of the image acquisition apparatus in FIG. 1 and illustrates a state in which the power connection switch and a power-supply switch are both closed.

### DETAILED DESCRIPTION OF THE INVENTION

An image acquisition apparatus 1 according to an embodiment of the present invention will be described below with reference to the drawings.

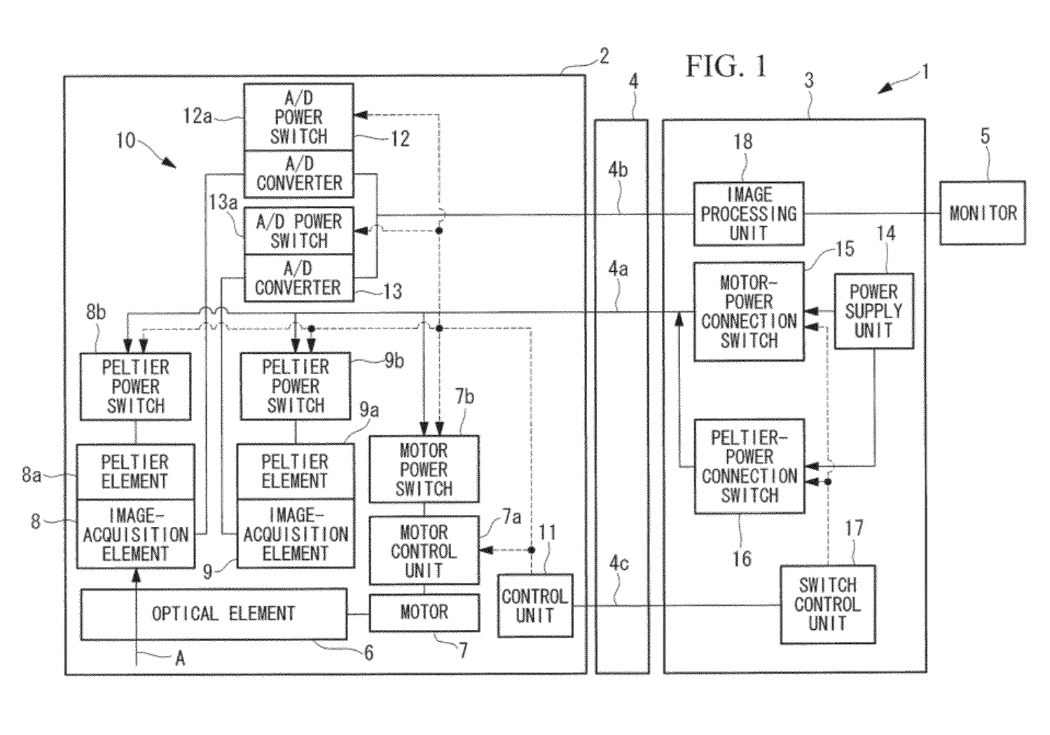

As illustrated in FIG. 1, the image acquisition apparatus 1 of this embodiment includes a camera unit 2, a control unit 3, a camera cable 4, which connects the camera unit 2 and the control unit 3, and a monitor 5.

The camera unit 2 includes an optical element (optical system) 6, where light A from the object is collected, a motor (driving element, electric-power element) 7, which drives the optical element 6, a first image-acquisition element 8 and a second image-acquisition element 9, which acquire images of the light A collected by the optical element 6, a signal processing unit 10, which processes the image signals acquired by the image-acquisition elements 8 and 9, and a control unit (electric-power switching unit) 11, which controls these components.

The optical element 6 is, for example, a mirror swiveled by the motor 7.

The motor 7 moves the optical element 6 so that the optical element 6 is alternatively positioned in such a manner that the light A from the object is incident on one of the image-acquisition elements 8 and 9.

The first image-acquisition element 8 includes a first Peltier element (cooling device, electric-power element) 8a; and the second image-acquisition element 9 includes a second Peltier element (cooling device, electric-power element) 9a. For example, the first image-acquisition element 8 and the first Peltier element 8a constitute a single electric-power element.

The motor 7 includes a motor control unit 7a and a motor power switch 7b, which switches on and off the power supply to the motor control unit 7a.

The first Peltier element 8a includes a first Peltier power switch 8b, which switches on and off the power supply to the first Peltier element 8a; and the second Peltier element 9a includes a second Peltier power switch 9b, which switches on and off the power supply to the second Peltier element 9a.

The signal processing unit 10 includes, for example, a first A/D converter 12, which is connected to the first image-acquisition element 8 and has a first A/D power switch 12a for switching on and off the power supply to the first A/D converter 12, and a second A/D converter 13, which is connected to the second image-acquisition element 9 and has a second A/D power switch 13a for switching on and off the power supply to the second A/D converter 13.

The control part 11 receives an instruction signal from the control unit 3 to switch on and off the Peltier power switches 8b and 9b, the A/D power switches 12a and 13a, and the motor power switch 7b.

The control unit 3 includes a power supply unit 14, which is disposed outside the camera unit 2 and supplies electric power to the camera unit 2; a motor-power connection switch 15, which switches the connection between the power supply unit 14 and the motor 7; a Peltier-power connection switch 16, which switches the connection between the power supply unit 14 and the Peltier elements 8a and 9a; a switch control unit 17, which controls the switches 15 and 16 and outputs an instruction signal to the control part 11 in the camera unit 2; and an image processing unit 18, which generates an image by processing an image signal sent from the signal processing unit 10. The image generated by the image processing unit 18 is displayed on the monitor 5,

One of the ends of the camera cable 4 is connected to the power supply unit 14 via the motor-power connection switch 15 and the Peltier-power connection switch 16, which are connected in parallel in the control unit 3; and the other end of the camera cable 4 has a power cable 4a, which is connected to the motor power switch 7b and the Peltier power switches 8b and 9b in the camera unit 2. Specifically, the power supply path from the power supply unit 14 to the first Peltier element 8a, the power supply path from the power supply unit 14 to the second Peltier element 9a, and the power supply path from the power supply unit 14 to the motor 7 share the power cable 4a. The A/D converters 12 and 13 in the camera unit 2 and the image processing unit 18 in the control unit 3 are connected via a signal cable 4b. The control part 11 in the camera unit 2 and the switch control unit 17 in the control unit 3 are connected via a signal cable 4c.

The switch control unit 17 in the control unit 3 and the control part 11 in the camera unit 2 operate as described below.

To acquire an image of an object with one of the image-acquisition elements 8 and 9, the switch control unit 17 supplies power to the camera unit 2 via the power cable 4a with the Peltier-power connection switch 16 closed and then outputs a signal indicating the closed state of the Peltier-power connection switch 16 to the control part 11 via the signal cable 4c.

After a predetermined amount of time has passed from receiving the signal indicating the closed state of the Peltier-power connection switch 16, the control part 11 in the camera unit 2 supplies power to the image-acquisition element 8 (9) by closing the Peltier power switch 8b (9b), which is disposed on the Peltier element 8a (9a) in the image-acquisition element 8 (9) to be operated. The image-acquisition element 8 (9) to be operated is the one that is disposed in the light path in which the optical element 6 is disposed.

The image-acquisition element 8 (9) is operated at a predetermined amount of time after power is supplied to the Peltier element 8a (9a).

The image signal corresponding to the image of the object acquired as a result of the operation of the image-acquisition element 8 (9) is sent to the A/D converter 12 (13), where it is converted to a digital signal, is then sent to the image processing unit 18 in the control unit 3 via the signal cable 4b, and is finally displayed on the monitor 5 as an image generated by the image processing unit 18.

After a predetermined amount of time from stopping the operation of the image-acquisition element 8 (9) after acquisition of an image of the object through the operation of the image-acquisition element 8 (9), the control part 11 stops supplying power to the Peltier element 8a (9a) by opening the Peltier power switch 8b (9b) and sends a signal indicating the open state of the Peltier power switch 8b (9b) to the switch control unit 17 in the control unit 3 via the signal cable 4c.

After a predetermined amount of time has passed from receiving the signal indicating the open state of the Peltier power switch 8b (9b), the switch control unit 17 opens the Peltier-power connection switch 16.

After a predetermined amount of time has passed from opening the Peltier-power connection switch 16, the switch control unit 17 closes the motor-power connection switch 15 to switch the light path by moving the optical element 6.

To switch the light path, the motor 7 is operated to move the optical element 6 such that the optical element 6 is disposed in the optical axis of the other image-acquisition element 9 (8) so as to enable image acquisition by the image-acquisition element 9 (8).

First, the switch control unit 17 closes the motor-power connection switch 15 to supply power to the camera unit 2 via the power cable 4a and then outputs a signal indicating the closed state of the motor-power connection switch 15 to the control part 11 via the signal cable 4c.

After a predetermined amount of time has passed from receiving the signal indicating the closed state of the motor-power connection switch 15, the control part 11 in the camera unit 2 operates the motor control unit 7a by closing the motor power switch 7b of the motor 7 to supply power to the motor control unit 7a. The control part 11 sends a control signal to the motor control unit 7a to dispose the optical element 6 in the light path of the image-acquisition element 9 (8), which is to perform image acquisition next.

Upon disposing the optical element 6 at a desired position, the control part 11 stops the motor 7, then, after a predetermined amount of time, opens the motor power switch 7b and sends a signal indicating the open state of the motor power switch 7b to the switch control unit 17 in the control unit 3 via the signal cable 4c. After a predetermined amount of time has passed from receiving the signal indicating the open state of the motor power switch 7b, the switch control unit 17 opens the motor-power connection switch 15.

Similar to the above-described image acquisition by one of the image-acquisition elements 8 (9), subsequently, image acquisition by the other image-acquisition element 9 (8) is performed.

The operation of the image acquisition apparatus 1 according to this embodiment, having the configuration described above, will be described below.

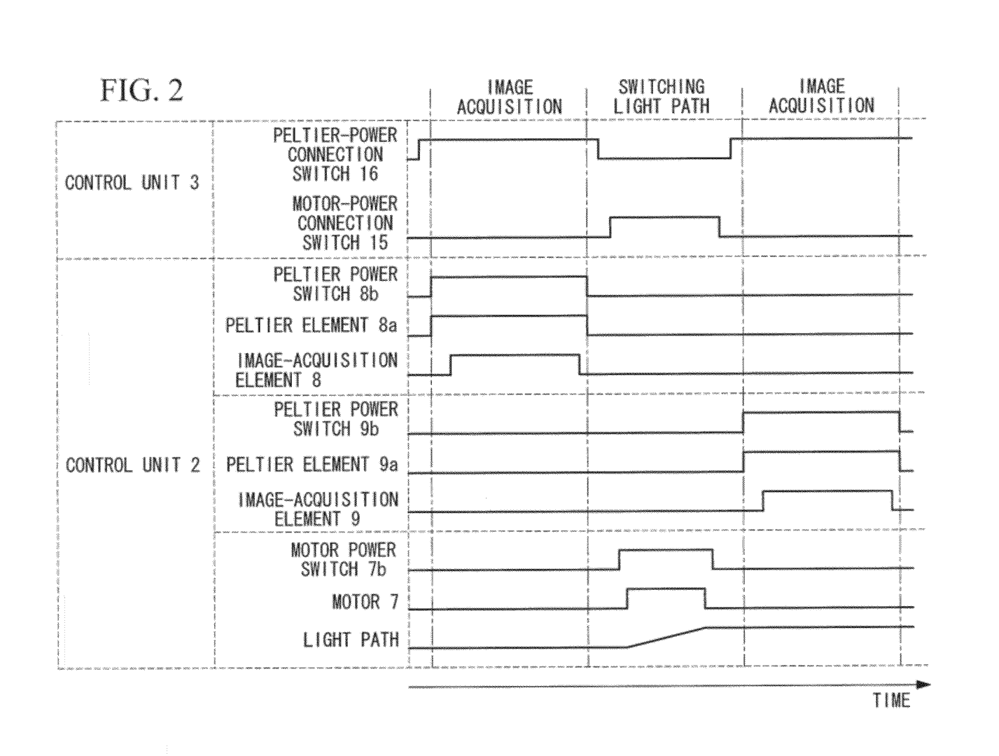

To perform image acquisition of an object with the image acquisition apparatus 1 according to this embodiment, as illustrated in FIG. 2, the Peltier-power connection switch 16 in the control unit 3 is closed by the switch control unit 17 in the control unit 3; then, the control part 11 closes the Peltier power switch 8b (9b) of the image-acquisition element 8 (9) in the camera unit 2 to operate the image-acquisition element 8 (9).

In this way, an image of the object is acquired by the image-acquisition element 8 (9). In such a case, the image-acquisition element 8 (9) is cooled by the Peltier element 8a (9a), which receives power before operating the image-acquisition element 8 (9); thus, heat emission during operation of the image-acquisition element 8 (9) is suppressed, enabling image acquisition while preventing condensation due to a temperature difference.

Upon completion of image acquisition, the control part 11 in the camera unit 2 stops the operation of the image-acquisition element 8 (9) and then opens the Peltier power switch 8b (9b).

Subsequently, to perform image acquisition of an object with the other image-acquisition element 9 (8), the switch control unit 17 in the control unit 3 opens the Peltier-power connection switch 16 in the control unit 3 after receiving the signal indicating completion of image acquisition by the image-acquisition element 8 (9) from the control part 11 in the camera unit 2 and then closes the motor-power connection switch 15.

Then, the control part 11 in the camera unit 2 closes the motor power switch 7b to operate the motor 7 so as to move the optical element 6 to a desired position. While the motor 7 is operating, the operation of the Peltier elements 8a and 9a is stopped. Upon stopping the operation of the motor 7 once the movement of the optical element 6 is completed, the motor power switch 7b is opened, and then the motor-power connection switch 15 in the control unit 3 is opened.

Subsequently, the Peltier-power connection switch 16 in the control unit 3 is closed again by the switch control unit 17 in the control unit 3. Then, the control part 11 in the camera unit 2 closes the Peltier power switch 9b (8b) of the other image-acquisition element 9 (8) to operate the image-acquisition element 9 (8).

In this way, image acquisition of the object is performed by the other image-acquisition element 9 (8). In such a case, the image-acquisition element 9 (8) is cooled by the Peltier element 9a (8a), which receives power before operating the image-acquisition element 9 (8); thus, heat emission during operation of the image-acquisition element 9 (8) is suppressed, enabling image acquisition while preventing condensation due to a temperature difference.

Upon completion of image acquisition, the control part 11 in the camera unit 2 stops the operation of the image-acquisition element 9 (8) and then opens the Peltier power switch 9a (8a). Then, the switch control unit 17 in the control unit 3 opens the Peltier-power connection switch 16.

In the image acquisition apparatus 1 according to this embodiment as described above, since image acquisition of the object by the image-acquisition elements 8 and 9 and the moving of the optical element 6 between the image-acquisition elements 8 and 9 are switched using the single power cable 4a, separate power cables are not required for the Peltier elements 8a and 9a of the image-acquisition elements 8 and 9 and the motor 7 driving the optical element 6, which require electric power, and thus, the size of the image acquisition apparatus 1 can be reduced by reducing the diameter of the camera cable 4.

Since power is supplied to the Peltier elements 8a and 9a and/or the motor 7, before operation of the Peltier elements 8a and 9a and/or the motor 7, the incoming current can be reduced to reduce the permitted current of the power cable 4a, and the diameter of the camera cable 4 can be reduced.

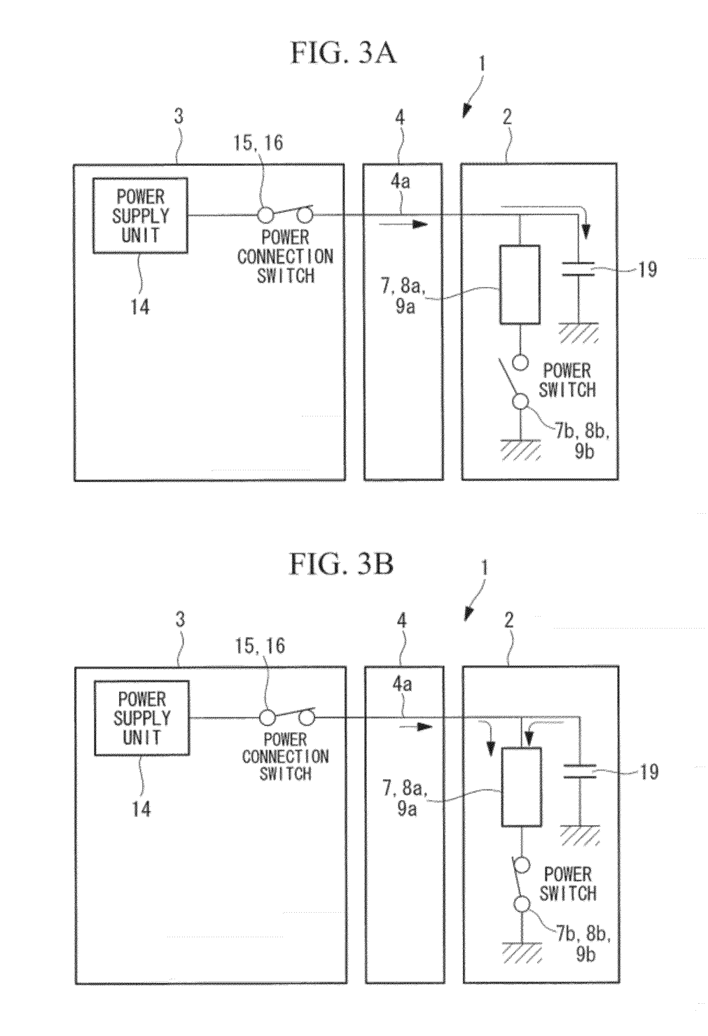

In this embodiment, as illustrated in FIGS. 3A and 3B, a capacitor (capacitive element) 19 may be disposed in parallel with electric power elements, such as the Peltier elements 8a and 9a and the motor 7.

In this way, for example, by carrying out a sequence for applying a current to the Peltier-power connection switch 16 and then to the Peltier power switch 8b (9b), the current applied through the power cable 4a can be reduced.

That is, as illustrated in FIG. 3A, when power from the power supply unit 14 is supplied to the Peltier element 8a (9a) to close the Peltier-power connection switch 16 and the Peltier power switch 8b (9b) is opened, the capacitor 19, which is connected in parallel with the Peltier element 8a (9a), is charged. Then, as illustrated in FIG. 3B, when the Peltier power switch 8b (9b) is closed, the power supplied via the power cable 4a and the electric charge stored in the capacitor 19 flow into the Peltier element 8a (9a). Since the power required by the Peltier element 8a (9a) is predetermined, the power sent through the power cable 4a can be reduced. The same advantages can also be achieved for the motor 7.

The present invention is not limited to the configuration and shape in the embodiment described above, and various changes and modifications can be made.

For example, the optical element 6 that sends the light A to the image-acquisition elements 8 and 9 may be a prism, instead of a mirror. In addition to the Peltier elements 8a and 9a, which respectively cool the image-acquisition elements 8 and 9, fans (not shown) that promote heat dissipation of the Peltier elements 8a and 9a can be provided.

The power supply that supplies power to the camera unit 2 may selectively supply power not only to the Peltier elements 8a and 9a after switching the light path but also to an image shift unit and an objective-lens moving unit.

In this embodiment, the Peltier power switches 8b and 9b or the motor power switch 7b are closed after a predetermined amount of time has passed from closing the Peltier-power connection switch 16 or the motor-power connection switch 15, and the Peltier-power connection switch 16 or the motor-power connection switch 15 is opened after a predetermined amount of time has passed from opening the Peltier power switches 8b and 9b or the motor power switch 7b; it is preferable, however, that the predetermined amounts of time be set in accordance with the load capacity of the Peltier elements 8a and 9a or the motor 7.

In this way, a large current is prevented from continuously flowing through the power cable 4a while the switches 7b, 8b, and 9b are closed or open, and thus, the load on the power supply unit 14 and the load on the camera cable 4 can be reduced. As a result, the maximum current flowing through the power cable 4a can be reduced, and the diameter of the camera cable 4 can be reduced even more.

What is claimed is:

1. An image acquisition apparatus comprising:
a camera unit including
a plurality of electric-power elements, which require electric power to acquire an image of an object, and
an electric-power switching unit configured to switch an electric power supply to each of the electric-power elements;
a control unit configured to output a switch instruction to the electric-power switching unit and to control the electric power supply to the camera unit; and
a cable configured to connect the control unit and the camera unit.

2. The image acquisition apparatus according to claim 1, wherein the electric-power elements include an image acquisition element having a cooling device and a driving element configured to move an optical system for guiding light to the image acquisition element.

3. The image acquisition apparatus according to claim 1, wherein the electric-power switching unit switches the electric power supply before the electric-power elements operate.

4. The image acquisition apparatus according to claim 1, wherein the electric-power switching unit switches the electric power supply a certain amount of time before the electric-power elements operate, the amount of time being set on the basis of at least one of total power consumption and load capacity of the electric-power element to which the power supply is switched.
